(19) United States
(12) Patent Application Publication
(10) Pub. No.: US 2019/0187799 A1
(43) Pub. Date: Jun. 20, 2019

(54) SELECTING AN APPLICATION FOR A CLIENT DEVICE TO EXECUTE AFTER THE CLIENT DEVICE EXITS A LOCKED STATE

(71) Applicant: Facebook, Inc., Menlo Park, CA (US)

(72) Inventor: Daniel Tam, San Francisco, CA (US)

(21) Appl. No.: 15/846,149

(22) Filed: Dec. 18, 2017

(51) Int. Cl. G06F 3/01; G06F 21/51

(52) U.S. Cl. CPC G06F 3/017; G06F 21/31; G06F 3/013; G06F 21/51

(57) ABSTRACT

A client device may operate in a locked state that provides limited functionality to a user. When the client device receives authentication information from a user, the client device exits the locked state and provides full functionality to the user. When providing the authentication information to the client device, the user may provide an additional input causing the client device to launch a specific application when exiting the locked state. The additional input may be a unique authentication code associated with an application, causing the client device to execute the application corresponding to a received authentication code. Any suitable type of additional input may be provided to cause the client device to execute the specific application. Example types of additional input include alphanumeric characters, a gesture, motion of the client device, and the user's eye position.

### BACKGROUND

This disclosure relates generally to presenting content via client device, and more specifically to selecting an application for the client device to execute when the client device leaves a locked state.

Users increasingly access content through client devices having more states providing users with limited functionality. For example, many client devices have a “locked state” that responds to a reduced set of inputs from the user and passively displays information to a user. Such a locked state may prevent other users from accessing a client device or may conserve computing resources of the client device.

Although certain applications may present content to the user while a client device executing the applications is in a locked state, many client devices require a user to provide authentication information to the client device and subsequently select an application for the client device to present content from the application. For example, a user provides a specific input to the client device to exit the locked state and subsequently provides authentication information for the client device to exit the locked state. After the client device exits the locked state, the client device does not present content from an application to the user until the user selects the application while the client device is not in the locked state. Providing multiple inputs to a client device before the client devices presents content from an application may discourage the user from viewing content from various applications or may reduce a likelihood of the user viewing content provided by one or more applications via a client device.

### SUMMARY

A client device executes one or more applications that present content to a user via the client device. For example, an application presents content received from an online system via a display device of the client device. The user selects an application via an input device of the client device to cause the client device to present content from the application to the user. However, the client device may operate in a locked state at various times. While in the locked state, the client device responds to a reduced set of inputs from the user, and may present limited content to the user.

While the client device is in the locked state and providing limited functionality to the user, the client device receives an input from the user to exit the locked state and provide full functionality to the user. After receiving the input to exit the locked state, the client device prompts the user to provide authentication information to the client device. The authentication information is any suitable information the client device associates with the user, which allows the client device to verify that the user from whom the input was received is authorized to change the state in which the client device operates or to otherwise access the client device. For example, the client device stores an alphanumeric string or biometric information in association with the user. Accordingly, after receiving the input from the user to exit the locked state, the client device receives authentication information from the user while the client device is in the locked state providing limited functionality to the user.

In addition to receiving the input to exit the locked state and to receiving the authentication information from the user, the client device receives an additional input from the user while the client device is in the locked state. The additional input identifies a specific application installed on the client device. In various embodiments, the client device stores associations between different inputs and different applications installed on the client device. The user provides the associations between inputs and applications installed on the client device via interactions with the client device in some embodiments, and the client device stores the associations between inputs and applications installed on the client device.

In some embodiments, the client device receives the additional input after receiving the authentication information from the user and while operating in the locked state. Alternatively, the client device receives the additional input before receiving the authentication information and while operating in the locked state. In other embodiments, the client device receives the additional input concurrently with receiving the authentication information while operating in the locked state.

The client device may receive any suitable type of additional input in various embodiments. For example, the additional input is one or more alphanumeric characters associated with the specific application. As another example, the additional input is a particular gesture received by the input device corresponding to the specific application; in an example, the user contacts a specific portion of the input device for the client device to receive the additional input. In another example, the user contacts a portion of the input device of the client device and continues contacting the input device along a path from the portion of the input device to another portion of the input device to provide the additional input to the client device. Alternatively, a type of contact with the input device by the user causes the client device to receive the additional input. For example, the user contacts the input device with a specific finger or other portion of the user's body to provide the additional input to the client device. In another example, the user contacts the input device with a specific (or with at least a threshold) force for the client device to receive the additional input. Alternatively, the user contacts the input device for a specific time interval (or for at least a threshold time interval) for the client device to receive the additional input.

The client device may receive the additional input from a component other than the input device of the client device. For example, the additional input is received based on a change in position of the client device determined from one or more position sensors included in the client device. As a specific example, the additional input is a rotation of the client device by at least a threshold amount along an axis. In another specific example, the additional input is changing a position of the client device in a particular direction (or changing the position of the client device by at least a threshold amount in the particular direction) determined form the one or more position sensors. Alternatively, the additional input is received when a gaze tracking system determines the user's gaze is directed to a specific location or determines that the user's gaze has moved in a specific direction from a previously detected position of the user's gaze. Hence, the client device may receive any suitable input as the additional input.

The client device determines whether the received authentication information matches information maintained by the client device that identifies the user. For example, the client device determines whether received alphanumeric characters match alphanumeric characters maintained by the client device in association with the user. As another example, the client device determines whether received biometric information matches biometric information the client device has stored in association with the user. In response to determining the received authentication information matches information maintained by the client device that identifies the user, the client device exits the locked state and launches the specific application identified by the additional input when the locked state is exited. This allows the client device to launch the specific application when exiting the locked state, so content from the specific application is presented to the user when the client device exits the locked state and operates in an operating state where full functionality is provided to the user. Launching the specific application when exiting the locked state allows the user to access the application without identifying the specific application after the client device exits the locked state and provides full functionality to the user, simplifying launching of the specific application by the client device by reducing an amount of user interaction with the client device and reducing an amount of time for client device to launch the specific application when the locked state is existed. This simplification of launching applications when the client device exits a locked state allows the user to more readily access one or more applications installed on the client device, increasing user interaction with the one or more applications installed on the client device.

### BRIEF DESCRIPTION OF THE DRAWINGS

FIG. 1 is a block diagram of a system environment in which an online system operates, in accordance with an embodiment.

FIG. 2 is a block diagram of a client device, in accordance with an embodiment.

FIG. 3 is a flowchart of a method for selecting an application for a client device to execute when the client device exits a locked state, in accordance with an embodiment.

FIG. 4 is a conceptual diagram of selecting an application for a client device to execute when the client device exits a locked state, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

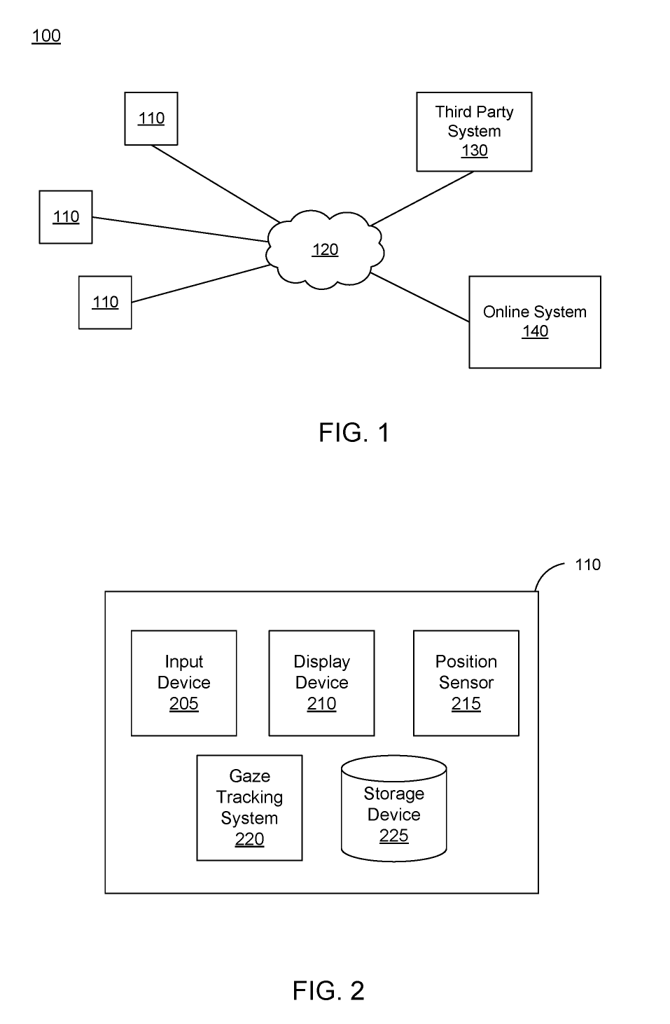

FIG. 1 is a block diagram of a system environment 100 including a client device 110. The system environment 100 shown by FIG. 1 comprises one or more client devices 110, a network 120, one or more third-party systems 130, and an online system 140. In alternative configurations, different and/or additional components may be included in the system environment 100. For example, the online system 140 is a social networking system, a content sharing network, a messaging server, or another system providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch, or another suitable device. A client device 110 is configured to communicate via the network 120. In one embodiment, a client device 110 executes various applications that each present content to a user via the client device 110. For example, the client device 110 executes an application allowing a user of the client device 110 to interact with the online system 140. As a specific example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™. An example client device 110 is further described below in conjunction with FIG. 2.

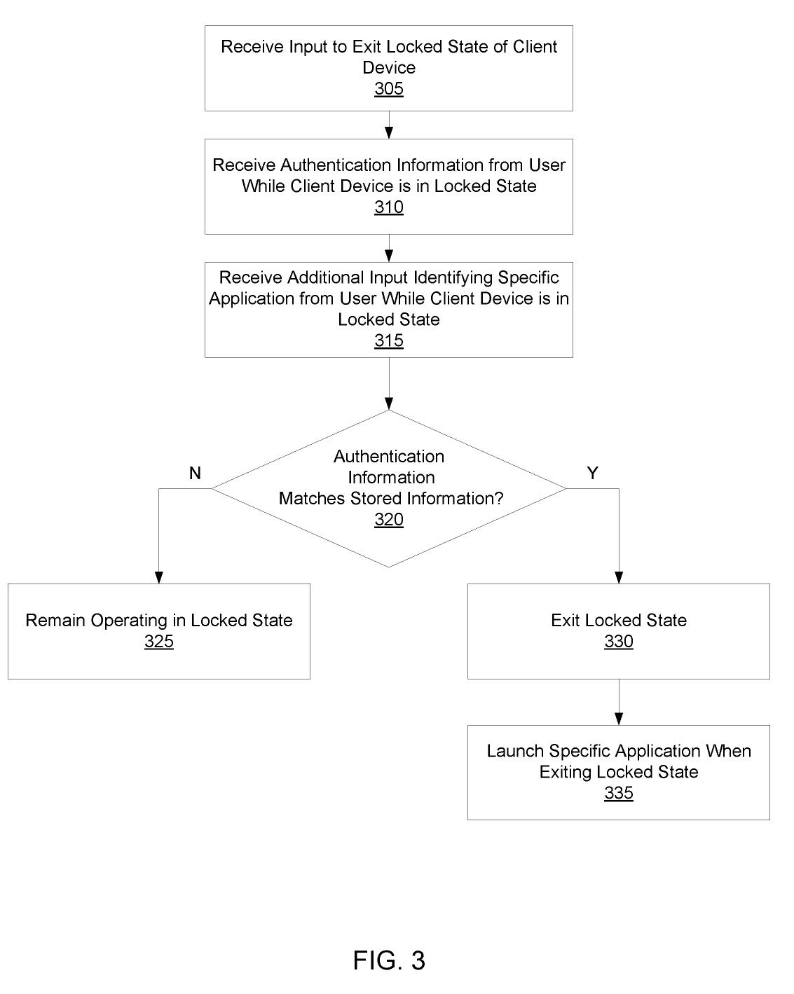

A client device 110 may have different states of functionality. A state of functionality describes the ability of the client device 110 to interact with the user and an online system 140. For example, the client device 110 has a powered down state, where the user and the online system 140 are unable to interact with the client device 110, an operating state where the client device 110 is capable of receiving and processing a full set of user inputs, and a locked state where the client device 110 provides a user with limited functionality. As used herein, a client device 110 in a locked state responds to a reduced set of inputs from the user, and may present content to the user. Additionally, the client device 110 may communicate with the online system 140 while in the locked state in various embodiments. The client device 110 enters the locked state based on an input from the user to the client device 110 to present a lock screen and to respond to a limited set of inputs in various embodiments. As another example, the client device 110 operates in the locked state if the client device 110 does not receive an input from the user for at least a threshold amount of time. In another example, the client device 110 operates in the locked state when the client device 110 operates in a “low power state” (e.g., reduced voltage/reduced clock frequency of a processor, etc.). The client device 110 exits the locked state and into the operating state in response to receiving one or more particular inputs from the user while operating in the locked state, as further described below in conjunction with FIG. 3.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

Various third party systems 130 provide content to users of the online system 140. For example, a third party system 130 maintains pages of content that users of the online system 140 may access through one or more applications executing on a client device 110. The third party system 130 may provide content items to the online system 140 identifying content provided by the online system 130 to notify users of the online system 140 of the content provided by the third party system 130. For example, a content item provided by the third party system 130 to the online system 140 identifies a page of content provided by the online system 140 that specifies a network address for obtaining the page of content.

The online system 140 provides content to a client device 110 for presentation to a user. In various embodiments, the online system 140 maintains information associated with the user and uses the maintained information to select content for presentation to the user. For example, the online system 140 stores actions performed by the user and received from the client device 110 or from third party systems 130. Based on the stored actions, the online system 140 selects content for presentation to the user and provides the content to the client device 110 via the network 120. The online system 140 may alternatively or additionally store connections between the user and other users or content previously presented to the user. The online system 140 may provide content to a client device 110 for presentation by an application executing on the client device 110 and associated with the online system 140 in various embodiments.

### Client Device Architecture

FIG. 2 is a block diagram of one embodiment of an architecture of a client device 110. The client device 110 shown in FIG. 2 includes one or more input devices 205, a display device 210, one or more position sensors 215, a gaze tracking system 220, and a storage device 225. In other embodiments, the client device 110 may include additional, fewer, or different components for various applications. Further, various components of the client device 110 may provide various combinations of the functionality further described below in some embodiments.

One or more input devices 205 included in the client device 110 receives input from the user. Different input devices 205 may be included in the client device 110. For example, the client device 110 includes a touch-sensitive display for receiving input data, commands, or information from a user. Using a touch-sensitive display allows the client device 110 to combine the display device 210 and an input device 205, simplifying user interaction with presented content items. In other embodiments, the client device 110 may include a keyboard, a trackpad, a mouse, or any other device capable of receiving input from a user. In another example, the input device 205 is configured to receive information from a user of the client device through a touchless interface. Examples of a touchless interface include sensors, such as an image capture device, to receive gestures from a client device user without the user physically contacting the client device 110. Additionally, the client device 110 may include multiple input devices 205 in some embodiments.

A display device 210 included in the client device 110 presents content items to a user of the client device 110. In some embodiments, the display device 210 is integrated into a client device 110 as a display screen. Examples of the display device 210 include a liquid crystal display (LCD), an organic light emitting diode (OLED) display, an active matrix liquid crystal display (AMLCD), or any other suitable device. Different client devices 110 may have display devices 210 with different characteristics. For example, different client devices 110 have display devices 210 with different display areas, different resolutions, or differences in other characteristics.

Alternatively, the display device 210 is a monitor or other display coupled to the client device 110. In other embodiments, the display device 210 is included in a headset or head mounted device (HMD) coupled to the client device 110 and configured to be worn on a user's head. Such a headset or HMD may include additional components that position the display device 115 relative to a user's eyes so content presented by the display device 210 presents a virtual environment to the user. Alternatively, the display device 210 is integrated into the client device 110, and the client device 110 is positioned within a headset or HMD so the display device 210 integrated into the client device 110 is positioned relative to the user's eyes so content presented by the display device 210 presents a virtual environment to the user. Content presented by the display device 115 is determined by an application executing on the client device 110. Different applications may be included on the client device 110, so execution of different applications changes the content presented by the user by the display device 115.

The position sensor 215 determines a geographic location associated with the client device 110. For example, a position sensor 215 is a global positioning system (GPS) sensor that determines a geographic location associated with the client device 110 based on information obtained from GPS satellites communicating with the GPS sensor, such as coordinates specifying a latitude and longitude of the location associated with the client device 210. As another example, a position sensor 215 determines a location associated with the client device 110 based on intensities of signals received from one or more access points (e.g., wireless access points) by the client device 110. In the preceding example, the position sensor 215 determines a location associated with the client device 110 based on signal intensity between the client device 110 and one or more wireless access points and service set identifiers (SSIDs) or media access control (MAC) addresses of the wireless access points. However, the client device 110 may include any suitable type of position sensor 215. In various embodiments, the client device 110 may include multiple position sensors 215.

In some embodiments, the position sensor 215 also determines movement or orientation of the client device 110. For example, the position sensor includes 215 one or more gyroscopes or accelerometers. In an example, a gyroscope included in the position sensor 215 determines a rotation or another change in orientation of the client device 110 relative to a prior position or relative to a reference position. As another example, an accelerometer included in the position sensor 215 allows the client device 215 to determine a change in position of the client device 110.

In various embodiments, the client device 110 includes a gaze tracking system 220 configured to capture information identifying locations of the display device 210 where a user's gaze was directed at different times. In various embodiments, a gaze tracking system 220 comprises an image capture device configured to capture images of portion of a user's face including the user's eyes. The gaze tracking system 220 includes instructions that, when executed by a processor, analyze the segments of the captured images including the user's eyes and identify a location where the user's gaze was directed based on characteristics of the user's eyes in the segments of the captured images.

The storage device 225 includes instructions that, when executed by a processor included in the client device 110, modifies a state in which the client device 110. As further described above in conjunction with FIG. 1, a state of functionality describes the ability of the client device 110 to interact with the user and an online system 140. Based on information from one or more of the input device 205, the position sensor 215, and the gaze tracking system 220, and instructions included in the storage device 225, the processor included in the client device 110 changes the state in which the client device 110 operates. For example, instructions included in the client device 110, when executed, transition the client device 110 between an operating state where the client device 110 is capable of receiving and processing a full set of user inputs and a locked state where the client device 110 provides a user with limited functionality. As used herein, a client device 110 in a locked state responds to a reduced set of inputs from the user, and may present content to the user. Instructions included in the storage device 225 also identify inputs received from the input device 205, the position sensor 215, or the gaze tracking system 220 that cause the processor to change a state in which the client device 110.

Additionally, as further described below in conjunction with FIG. 3, the storage device 225 includes information identifying a user of the client device 110. For example, the storage device 225 includes alphanumeric characters identifying the user. As another example, the storage device 225 stores biometric information in association with the user. When the client device 110 receives an input via the input device 205, the position sensor 215, or the gaze tracking system 220 to transition from the locked state to the operating state, the client device 110 prompts the user to provide authentication information that is compared to the stored information identifying the user. If the authentication information matches the stored information, the processor included on the client device 110 transitions the client device 110 from the locked state to the operating state.

### Selecting an Application for a Client Device to Execute when Exiting a Locked State

FIG. 3 is a flowchart of one embodiment of a method for selecting an application for a client device 110 to execute when the client device 110 exits a locked state. In other embodiments, the method may include different and/or additional steps than those shown in FIG. 3. Additionally, steps of the method may be performed in different orders than the order described in conjunction with FIG. 3 in various embodiments.

As further described above in conjunction with FIG. 1, a client device 110 executes one or more applications that present content to a user via the client device 110. For example, an application presents content received from an online system 140 via a display device 210 of the client device 110. The user selects an application via an input device 205 of the client device 110 to cause the client device 110 to present content from the application to the user. However, the client device 110 may operate in a locked state at various times, as further described above in conjunction with FIG. 1. While in the locked state, the client device 110 responds to a reduced set of inputs from the user, and may present limited content to the user.

While the client device 110 is in the locked state and providing limited functionality to the user, the client device 110 receives 305 an input from the user to exit the locked state and provide full functionality to the user. In various embodiments, the client device 110 includes information associating different inputs with exiting the locked state. For example, the client device 110 associates one or more specific gestures or one or more specific changes in position of the client device 110 with exiting the locked state.

After receiving 305 the input to exit the locked state, the client device 110 prompts the user to provide authentication information to the client device 110. The authentication information is any suitable information the client device 110 associates with the user, which allows the client device 110 to verify that the user from whom the input was received 305 is authorized to change the state in which the client device 110 operates or to otherwise access the client device 110. For example, the client device 110 stores an alphanumeric string in association with the user or stores biometric information associated with the user. In some embodiments, the client device 110 stores authentication information associated with multiple users, allowing different users to access the client device 110. Accordingly, after receiving 305 the input from the user to exit the locked state, the client device 110 receives 310 authentication information from the user while the client device 110 is in the locked state providing limited functionality to the user.

In addition to receiving 305 the input to exit the locked state and to receiving 310 the authentication information from the user, the client device 110 receives 315 an additional input from the user while the client device 110 is in the locked state. The additional input identifies a specific application installed on the client device 110. In various embodiments, the client device 110 stores associations between different inputs and different applications installed on the client device 110. The user provides the associations between inputs and applications installed on the client device 110 via interactions with the client device 110 in some embodiments, and the client device 110 stores the associations between inputs and applications installed on the client device 110. In some embodiments, the online system 140 maintains associations between applications and inputs in association with the user, and the client device 110 retrieves the associations from the online system 140 and locally stores the associations between applications and inputs. The client device 110 may associate an additional input with an application that was executing by the client device 110 prior to the client device 110 operating in the locked state in some embodiments.

In some embodiments, the client device 110 receives 315 the additional input after receiving 310 the authentication information from the user and while operating in the locked state. Alternatively, the client device 110 receives 315 the additional input before receiving 310 the authentication information and while operating in the locked state. In other embodiments, the client device 110 receives 315 the additional input concurrently with receiving 310 the authentication information while operating in the locked state.

The client device 110 may receive 315 any suitable type of additional input in various embodiments. For example, the additional input is one or more alphanumeric characters associated with the specific application. As another example, the additional input is a particular gesture received by the input device 205 corresponding to the specific application; in an example, the user contacts a specific portion of the input device 205 for the client device 110 to receive 315 the additional input. In another example, the user contacts a portion of the input device 205 of the client device 110 and continues contacting the input device 205 along a path from the portion of the input device 205 to another portion of the input device 205 to provide the additional input to the client device 110. Alternatively, a type of contact with the input device 205 by the user causes the client device 110 to receive 315 the additional input. For example, the user contacts the input device 205 with a specific finger or other portion of the user's body to provide the additional input to the client device. In another example, the user contacts the input device 205 with a specific (or with at least a threshold) force for the client device 110 to receive 315 the additional input. Alternatively, the user contacts the input device 205 for a specific time interval (or for at least a threshold time interval) for the client device 110 to receive 315 the additional input.

The client device 110 may receive 315 the additional input from a component other than the input device 205. For example, the additional input is received 315 based on a change in position of the client device 110 determined from one or more position sensors 215 included in the client device 110. As a specific example, the additional input is a rotation of the client device 110 by at least a threshold amount along an axis. In another specific example, the additional input is changing a position of the client device 110 in a particular direction (or changing the position of the client device 110 by at least a threshold amount in the particular direction) determined form the one or more position sensors 215. Alternatively, the additional input is received 315 when a gaze tracking system 220 determines the user's gaze is directed to a specific location or determines that the user's gaze has moved in a specific direction from a previously detected position of the user's gaze. Hence, the client device 110 may receive 315 any suitable input as the additional input.

The client device 110 determines 320 whether the received authentication information matches information maintained by the client device 110 that identifies the user. For example, the client device 110 determines 320 whether received alphanumeric characters match alphanumeric characters maintained by the client device 110 in association with the user. As another example, the client device 110 determines 320 whether received biometric information matches biometric information the client device 110 has stored in association with the user. If the client device 110 determines 320 the received authentication information does not match information maintained by the client device 110 that identifies the user, the client device 110 remains 325 operating in the locked state. In some embodiments, the client device 110 remains operating 325 in the locked state if the received additional input does not match a stored association between an input and an application executing on the client device 110.

However, responsive to determining 320 the received authentication information matches information maintained by the client device 110 that identifies the user, the online system 140 exits 330 the locked state and launches 335 the specific application identified by the additional input when the locked state is exited 330. This allows the client device 110 to launch 335 the specific application when exiting 330 the locked state, so content from the specific application is presented to the user when the client device 110 exits 330 the locked state and operates in an operating state where full functionality is provided to the user. Launching 335 the specific application when exiting 330 the locked state allows the user to access the application without identifying the specific application after the client device 110 exits the locked state 330 and provides full functionality to the user, simplifying launching of the specific application by the client device 110 by reducing an amount of user interaction with the client device 110 and reducing an amount of time for client device 110 to launch 335 the specific application when the locked state is existed 330. This simplification of launching applications when the client device 110 exits 330 a locked state allows the user to more readily access one or more applications installed on the client device 110, increasing user interaction with the one or more applications installed on the client device.

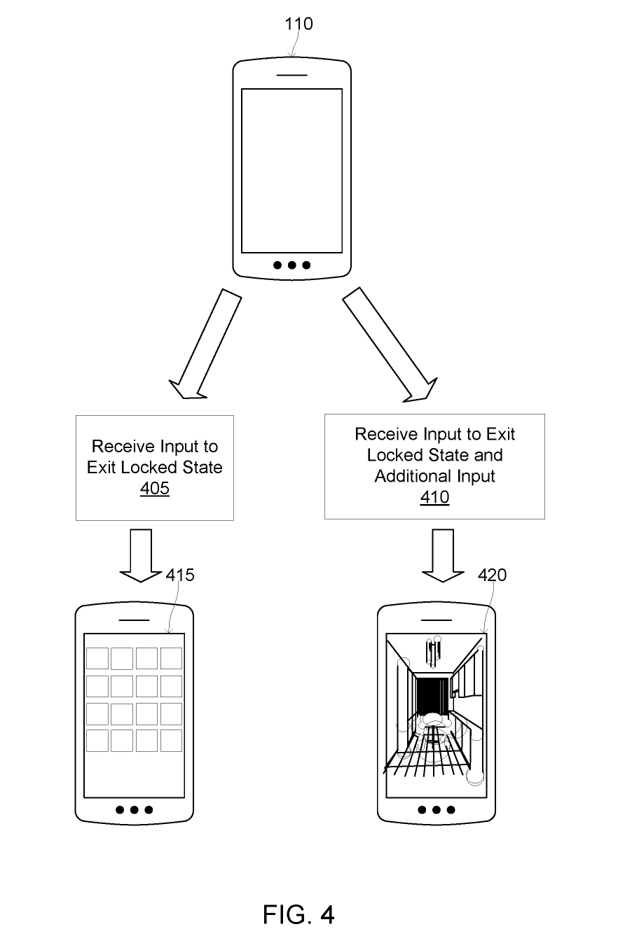

FIG. 4 is a conceptual diagram of selecting an application for a client device 110 to execute when the client device 110 exits a locked state. In the example of FIG. 4, the client device 110 is operating in a locked state that provides limited functionality to a user, as further described above in conjunction with FIGS. 1-3. When the client device 110 receives 405 an input to exit the locked state from a user, the client device 110 exits the locked state and enters an operating state in which full functionality is provided to the user. However, when the client device 110 exits the locked state, the client device 110 displays 415 information identifying various applications installed on the client device 110 to the user. To view content from a specific application, the user selects information identifying the specific application presented while the client device 110 is in the operating state, causing the client device 110 to launch the specific application and present content to the user.

However, to simplify launching of the specific application and to more quickly present content from the specific application to the user via the client device 110, when the client device 110 receives 410 an input to exit the locked state and an additional input that identifies the specific application. The additional input is further described above in conjunction with FIG. 3. In response to receiving the input to exit the locked state and the additional input, the client device 110 exits the locked state into an operating state and launches the specific application when the client device 110 exits the locked state. This causes the client device to display content 420 from the specific application when the client device 110 exits the locked state. Hence, providing the additional input along with the input to exit the locked state to the client device 110 while the client device 110 is in the locked state causes the client device 110 to launch the specific application and display (or otherwise present) content 420 from the specific application when the client device 110 exits the locked state, instead of having the user select the specific application after the client device 110 exits the locked state to be presented with content from the specific application.

### Conclusion

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving, at a client device, an input from a user to exit a locked state in which the client device provides limited functionality to the user while the client device is in the locked state;
receiving, at the client device, authentication information from the user while the client device is in the locked state;
receiving, at the client device, an additional input from the user, the additional input identifying a specific application installed on the client device;
responsive to the authentication information matching information identifying the user maintained by the client device, the client device exiting the locked state; and
launching the specific application identified by the additional input when the client device exits the locked state.

2. The method of claim 1, wherein receiving, at the client device, the additional input from the user, the additional input identifying a specific application installed on the client device comprises:
receiving the additional input before the client device receives the authentication information while the client device is in the locked state.

3. The method of claim 1, wherein receiving, at the client device, the additional input from the user, the additional input identifying a specific application installed on the client device comprises:
receiving the additional input after the client device receives the authentication information while the client device is in the locked state.

4. The method of claim 1, wherein launching the specific application identified by the received input when the client device exits the locked state comprises:
retrieving stored associations between one or more inputs and one or more applications operating on the client device;
identifying a stored association including the additional input; and
launching an application associated with the additional input by the identified stored association.

5. The method of claim 1, wherein the additional input comprises one or more alphanumeric characters.

6. The method of claim 1, wherein the additional input comprises a specific gesture received by an input device of the client device.

7. The method of claim 1, wherein the specific gesture comprises a type of contact with the input device by the user.

8. The method of claim 1, wherein the type of contact with the input device is selected from a group consisting of: contacting the input device with a specific force, contacting the input device with at least a threshold force, contacting the input device for a specific time interval, contacting the input device for at least a threshold time interval, contacting the input device with a specific part of the user, and any combination thereof.

9. The method of claim 1, wherein the additional input comprises a change in a position of the client device.

10. The method of claim 1, wherein the additional input comprises detecting a specific position of a gaze of the user by a gaze tracking system included in the client device.

11. The method of claim 1, wherein the specific application comprises an application executing prior to the client device operating in the locked state.

12. A computer program product comprising a non-transitory computer readable storage medium having instructions encoded thereon that, when executed by a processor, cause the processor to:
receive, at a client device, an input from a user to exit a locked state in which the client device provides limited functionality to the user while the client device is in the locked state;
receive, at the client device, authentication information from the user while the client device is in the locked state;
receive, at the client device, an additional input from the user, the additional input identifying a specific application installed on the client device;
responsive to the authentication information matching information identifying the user maintained by the client device, exit the locked state; and
launch the specific application identified by the additional input when the client device exits the locked state.

13. The computer program product of claim 12, wherein receive, at the client device, the additional input from the user, the additional input identifying a specific application installed on the client device comprises:
receive the additional input before the client device receives the authentication information while the client device is in the locked state.

14. The computer program product of claim 12, wherein receive, at the client device, the additional input from the user, the additional input identifying a specific application installed on the client device comprises:
receive the additional input after the client device receives the authentication information while the client device is in the locked state.

15. The computer program product of claim 12, wherein launching the specific application identified by the received input when the client device exits the locked state comprises:
retrieve stored associations between one or more inputs and one or more applications operating on the client device;
identify a stored association including the additional input; and
launch an application associated with the additional input by the identified stored association.

16. The computer program product of claim 12, wherein the additional input comprises one or more alphanumeric characters.

17. The computer program product of claim 12, wherein the additional input comprises a specific gesture received by an input device of the client device.

18. The computer program product of claim 12, wherein the specific gesture comprises a type of contact with the input device by the user.

19. The computer program product of claim 18, wherein the type of contact with the input device is selected from a group consisting of: contacting the input device with a specific force, contacting the input device with at least a threshold force, contacting the input device for a specific time interval, contacting the input device for at least a threshold time interval, contacting the input device with a specific part of the user, and any combination thereof.

20. The computer program product of claim 12, wherein the additional input comprises a change in a position of the client device.

21. The computer program product of claim 12, wherein the additional input comprises detecting a specific position of a gaze of the user by a gaze tracking system included in the client device.

22. The computer program product of claim 12, wherein the specific application comprises an application executing prior to the client device operating in the locked state.
